(19) United States
(12) Patent Application Publication
(10) Pub. No.: US 2008/0027169 A1
(43) Pub. Date: Jan. 31, 2008

(54) Thermohardenable Epoxy Resin-Based Compositions, 3(4)-(Aminomethyl)-Cyclohexane-Propanamine and 1,4(5)-Cyclooctane Dimethanamine

(75) Inventor: Martina Ortelt, Dulmen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA AG, DUESSELDORF GERMANY (DE)

(21) Appl. No.: 11/596,367

(22) PCT Filed: Mar. 21, 2005
(86) PCT No.: PCT/EP05/51290

§ 371 Date: Mar. 6, 2007

(30) Foreign Application Priority Data
May 14, 2004 (DE) 10-2004-024439.1

(51) Int. Cl. C08G 59/14

(52) U.S. Cl. 524/612; 525/403

(57) ABSTRACT

Curable compositions based on epoxy resins and 1-aminopropyl-3(4)(aminomethyl)cyclohexane and 1,4(5)-bisaminomethylcyclooctane The invention relates to curable compositions based on epoxy resins and 1-aminopropyl-3(4)-(aminomethyl)cyclohexane and 1,4(5)-bisaminomethylcyclooctane.

The invention relates to curable compositions based on epoxy resins and 1-aminopropyl-3(4)-(aminomethyl)cyclohexane and 1,4(5)-bisaminomethylcyclooctane.

Epoxy resins are prepolymers which contain two or more epoxide groups per molecule. The reaction of these resins with a number of curing agents leads to crosslinked polymers. An overview of the resins and curing agents and their use in properties is given in H. Schuhmann, “Handbuch Betonschutz durch Beschichtungen” [Handbook of Concrete Protection by means of Coatings], Expert Verlag 1992, pages 396 to 428.

It is known that cycloaliphatic diamines, e.g. isophoronediamine (IPD), can also be used in addition to numerous other amine curing agents for curing epoxy resins, for example those based on bisphenol A diglycidyl ether. However, the relatively low reactivity in comparison with aliphatic amines is disadvantageous in the applications.

Cycloaliphatic amines generally cure only incompletely at room temperature. In order to obtain adequate properties, it is important to achieve as high a degree of curing as possible.

Aliphatic amines, such as, for example, ethylenediamine, diethylenetriamine and triethylenetetramine, or araliphatic amines, such as, for example, m-xylylenediamine, are more reactive but have disadvantages, such as, inter alia, high vapor pressure or a high tendency to yellow.

There was therefore a need for amine curing agents which on the one hand have the advantages of the cycloaliphatic curing agent but on the other hand have a higher reactivity.

It has now been found that, with the use of 1-aminopropyl-3(4)-(aminomethyl)cyclohexane (C64-diamine) and/or 1,4(5)-bisaminomethylcyclooctane (BAMCO) as reactants in epoxy resins, good final properties result but at the same time good curing is obtained.

The invention relates to curable compositions substantially containing

A) at least one epoxy resin and

B) at least one curing agent selected from
B1) 1-aminopropyl-3(4)-(aminomethyl)cyclohexane (C64-diamine) or
B2) 1,4(5)-bisaminomethylcyclooctane (BAMCO)

and their use.

The amines B1) and B2) have the following formulae:

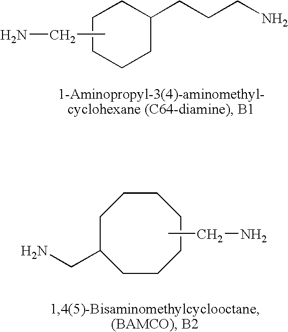

They are prepared from 4-vinylcyclohexene (C64-diamine) or 1,5-cyclooctadiene (BAMCO) via a carboxymethylation with subsequent reductive animation and consist of mixtures of different isomers.

Suitable epoxy resin components A) are in principle all epoxy resins which can be cured by means of amines. The epoxy resins include, for example, polyepoxides based on bisphenol A diglycidyl ether, bisphenol F diglycidyl ether or cycloaliphatic types. Preferably, however, epoxy resins based on bisphenol A and optionally those based on bisphenol F—optionally also as a mixture—are used. Resins and curing agents are preferably used in equivalent amounts. However, deviations from the stoichiometric ratio are also possible.

The curable compositions may also contain further amine curing agents which contain at least 2 or more primary and/or secondary amino groups, e.g. methylenedianiline, N-aminoethylpiperazine, isophoronediamine, m-phenylenebis(methylamine), trimethylhexamethylenediamine, polyoxyalkylenamines, polyaminoamides, reaction products of amines with acrylonitrile and Mannich bases. These are used in amounts of from 0.5 to 95% by weight, preferably in amounts of from 10 to 90% by weight and particularly preferably in amounts of from 50 to 80% by weight, based on amines used. Amines and epoxy resins are generally cured in a stoichiometric ratio. Deviations therefrom are, however, possible within a certain range depending on the type of curing agent and the application.

Depending on the corresponding field of use, epoxy resin formulations contain modifiers, reaction accelerators, relative diluents, solvents and/or additives, such as, inter alia, antifoams, fillers and/or pigments, in addition to a resin containing one or more epoxide groups and one or more curing agents.

In the case of fiber composite materials, the formulations additionally contain the corresponding fibers and/or nonwovens.

Particularly suitable modifiers are compounds such as, for example, benzyl alcohol, alkylphenols or hydrocarbon resins.

The reaction accelerators include, for example, organic acids, such as lactic acid and salicylic acid, or compounds of tertiary amines, such as, for example, tris(dimethylaminomethyl)phenol and benzyldimethylamine.

Suitable reactive diluents are, for example, mono- and polyfunctional, liquid epoxide compounds, such as, for example, 2-ethylhexyl glycidyl ether, hexanediol diglycidyl ether and trimethylolpropane diglycidyl ether.

The solvents which can be used include, for example, aromatic hydrocarbons, such as xylene, or alcohols, such as ethanol, propanols or butanols.

Furthermore, the pigments and fillers and additives typical for coatings are used.

Such systems are cured at different temperatures depending on the intended use. Thus, for example in the applications in the area of construction chemistry and corrosion protection, curing is generally effected at ambient temperature, whereas, for example in the case of fiber composite materials, curing is effected at elevated temperature (i.e. “hot curing”).

The invention also relates to the use of curable compositions in epoxide systems which are cured at ambient temperature, preferably at from 0 to 35° C., particularly preferably at from 5 to 30° C.

The invention also relates to the use of curable compositions, the epoxide systems being hot-cured, at from 50 to 180° C., preferably at from 80 to 180° C., particularly preferably at from 80 to 130° C.

The curable compositions are used in particular for coatings, in particular for coatings on metal, mineral substrates and plastics, and for floor coatings, finishes, polymer concrete, repair systems, anchor materials, adhesives, fiber composite materials, potting compounds and impregnations.

The examples which follow show results with the products according to the invention in various systems.

### EXAMPLES

TABLE 1
Room temperature curing

| | C64 diamine | BAMCO | IPD |
|---|---|---|---|
| Formulation components | Amounts in grams | | |
| Curing component | | | |
| Diamine C64 | 100 | — | — |
| BAMCO | — | 100 | — |
| Isophoronediamine | — | — | 100 |
| Benzyl alcohol | 30 | 30 | 30 |
| Resin component | | | |
| Amount of epoxy resin per | 33 | 33 | 30 |
| 100 g of curing agent | | | |
| (standard resin based on | | | |
| bisphenol A; e.g. | | | |
| Epikote 828) | | | |
| Properties | Evaluation | | |
| Brittleness | Not brittle/ | Not brittle/ | Brittle/in- |
| | completely | completely | sufficiently |
| | cured | cured | reacted |

With the reactive diamines C64 diamine and BAMCO, epoxide systems which are free of embrittlement and undergo better curing at room temperature are obtained.

TABLE 2
Room temperature curing

| Formulation components | | |
|---|---|---|
| Curing components | | |
| C64 diamine | 80 | — |
| BAMCO | — | 80 |
| Isophoronediamine | 20 | 20 |
| Benzyl alcohol | 88 | 88 |
| Salicylic acid | 12 | 12 |
| Standard resin based on | 20 | 20 |
| bisphenol A; e.g. | | |
| Epikote 828 | | |
| Resin component | | |
| Amount of epoxy resin per | 55 | 55 |
| 100 g of curing agent | | |
| (standard resin based on | | |
| bisphenol A; e.g. | | |
| Epikote 828) | | |
| Properties | | |
| Freedom from tack | <1 day | <1 day |
| Heat distortion resistance | | |
| after 1 day | 42° C. | 45° C. |
| After 7 days | 52° C. | 55° C. |
| Pendulum hardness | | |
| After 1 day | 125 | 140 |
| After 7 days | 205 | 210 |

With C64 diamine and BAMCO, it is possible to prepare very reactive, nontacky formulations having good properties, as mixtures with other amines, such as, for example, IPD.

TABLE 3
Hot curing

| | | | |
|---|---|---|---|
| Formulation components | | | |
| Curing component | | | |
| C64 diamine | 100 | — | — |
| BAMCO | — | 100 | — |
| IPD | — | — | 100 |
| Resin component | | | |
| Amount of epoxy | 23 | 23 | 23 |
| resin per 100 g of | | | |
| curing agent | | | |
| (standard resin | | | |
| based on bisphenol | | | |
| A; e.g. | | | |
| Epikote 828) | | | |
| Properties after | | | |
| curing 1 hour | | | |
| 50° C. + 1 hour | | | |
| 110° C. | | | |
| Heat distortion | 126° C. | 131° C. | 139° C. |
| resistance | | | |
| Water absorption | 4% by | 4% by | 4% by |
| after 28 days at | weight | weight | weight |
| 100° C. | | | |
| Acetone absorption | 6% by | 6% by | 16% by |
| after 28 days at | weight | weight | weight |
| 23° C. | | | |

With C64 diamine and BAMCO epoxide systems, it is possible to achieve the outstanding S heat distortion resistances as in the case of cycloaliphatic diamines but with improved acetone resistance.

1-28. (canceled)

29. A curable composition substantially containing
A) at least one epoxy resin whereas polyepoxides based on bisphenol A diglycidyl ether, bisphenol F diglycidyl ether and/or cycloaliphatic types being contained as epoxy resins, and
B) at least one curing agent selected from
B1) 1-aminopropyl-3(4)-(aminomethyl)cyclohexane (C64-diamine) or
B2) 1,4(5)-bisaminomethylcyclooctane (BAMCO)

30. The curable composition as claimed in claim 29 characterized in that modifiers are contained.

31. The curable composition as claimed in claim 30, characterized in that benzyl alcohol, alkylphenols or hydrocarbon resins are contained as modifiers.

32. The curable composition as claimed in claim 31, characterized in that benzyl alcohol is contained as a modifier.

33. The curable composition as claimed in claim 29, characterized in that reaction accelerators are contained.

34. The curable composition as claimed claim 29, characterized in that organic acids are contained as reaction accelerators.

35. The curable composition as claimed in claim 34, characterized in that lactic acid and/or salicylic acid are contained as reaction accelerators.

36. The curable composition as claimed in claim 33, characterized in that tertiary amines are contained as reaction accelerators.

37. The curable composition as claimed in claim 29, characterized in that reactive diluents are contained.

38. The curable composition as claimed in claim 31, characterized in that mono- or polyfunctional epoxide compounds are contained as reactive diluents.

39. The curable composition as claimed in claim 29, characterized in that solvents are contained.

40. The curable composition as claimed in claim 29, characterized in that additional pigments and/or fillers are contained.

41. The curable composition as claimed in claim 29, characterized in that additives are additionally contained.

42. The curable composition as claimed in claim 29, characterized in that further polyamines are contained.

43. The curable composition as claimed in claim 42, characterized in that isophoronediamine is contained.

44. The curable composition as claimed in claim 42, characterized in that trimethylhexamethylenediamine, m-phenylenebis(methylamine), 1,3- and/or 1,4-bis(aminomethyl)cyclohexane, methylenebis(4-aminocyclohexane), 3,3′-dimethyl-4,4′-diaminodicyclohexylmethane, tricyclododecanediamine, norbornanediamine, N-aminoethylpiperazine and or polyoxyalkylenamines are contained.

45. The curable composition as claimed in claim 42, characterized in that polyaminoamides, reaction products of amines with acrylonitrile and/or Mannich bases are contained.

46. The curable composition as claimed in claim 29, characterized in that further polyamines are contained in amounts of from 0.5 to 95% by weight, preferably in amounts of from 10 to 90% by weight and particularly preferably in amounts of from 50 to 80% by weight, based on amines used.

47. A method of using curable compositions as claimed in claim 29 in epoxide systems which are cured at ambient temperature.

48. The use as claimed in claim 47, the curing temperatures being between 0 and 35° C.

49. A method of using curable compositions as claimed in claim 29, the epoxide systems being hot-cured.

50. The use as claimed in claim 49, the curing temperatures during hot curing being between 50 and 180° C.

51. The use as claimed in claim 49, the curing temperatures during hot curing being between 80 and 150° C.

52. A method of using curable compositions as claimed in claim 29 in coatings.

53. The use as claimed in claim 52 for coatings on metal, mineral substrates and plastics.

54. The use as claimed in claim 52 for floor coatings.

55. The use of curable compositions as claimed in claim 29 in finishes.

56. A method of using curable compositions as claimed in claim 29 for polymer concrete, repair systems, anchor materials, adhesives, fiber composite materials, potting compounds and impregnations.
